(19) United States
(12) Patent Application Publication
(10) Pub. No.: US 2026/0188589 A1
(43) Pub. Date: Jul. 2, 2026

(54) MULTILAYER CERAMIC CAPACITOR

(71) Applicant: Murata Manufacturing Co., Ltd., Nagaokakyo-shi (JP)

(72) Inventors: Toshihiko KOBAYASHI, Nagaokakyo-shi (JP); Seiji KOGA, Nagaokakyo-shi (JP)

(21) Appl. No.: 19/551,846

(22) Filed: Feb. 27, 2026

Related U.S. Application Data
(63) Continuation of application No. PCT/JP2024/026664, filed on Jul. 25, 2024.

(30) Foreign Application Priority Data
Oct. 3, 2023 (JP) 2023-172016

(51) Int. Cl. H01G 4/248; H01G 4/30; H01G 13/00

(52) U.S. Cl. CPC H01G 4/248; H01G 4/30; H01G 13/006

(57) ABSTRACT

A multilayer ceramic capacitor includes a multilayer body including an outer electrode with a flat shape. The multilayer body has a dimension of about 0.8 mm or more in a stacking direction, a dimension of about 0.8 mm or more in a width direction, and a dimension of about 1.6 mm or more in a length direction, an outer electrode including Cu and with a thickness of about 15 μm or less on a main surface, an angle between the main surface and a surface of an edge portion of the outer electrode is about 39.1 degrees or less, and a ratio b/a of a maximum thickness b to a distance a is about 2.8 or less.

### CROSS REFERENCE TO RELATED APPLICATIONS

This application claims the benefit of priority to Japanese Patent Application No. 2023-172016 filed on Oct. 3, 2023 and is a Continuation application of PCT Application No. PCT/JP2024/026664 filed on Jul. 25, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In the related art, multilayer ceramic capacitors are manufactured by forming an outer electrode on an outer surface of a multilayer body including a stack of multiple dielectric layers and multiple inner electrodes.

In a known method for forming an outer electrode, while an outer electrode paste including a resin as a binder, a metal, and a solvent is used, an end surface of a multilayer body before formation of the outer electrode (hereinafter, referred to as a “fired multilayer chip body”) is immersed in the outer electrode paste, and the applied outer electrode paste is then dried. Typically, since the amount of the applied outer electrode paste is increased when the size of the fired multilayer chip body is increased, the outer electrode is likely to have a convex shape in which a central portion is thicker, whereas a surrounding portion is thinner. On the other hand, there is a known technique for forming an outer electrode whose flatness is improved by convection induced by evaporation of the solvent in the outer electrode paste during a period from application of the outer electrode paste onto the fired multilayer chip body until drying of the outer electrode paste.

When the above-described outer electrode paste in which convection occurs is applied to a fired multilayer chip body having a large size, in addition to the amount of the outer electrode paste adhering to an end portion of the fired multilayer chip body, the amount of the outer electrode paste that is spread from the end portion to main surfaces and side surfaces, while adhering thereto, is increased, and the occurrence of convection on the main surfaces and side surfaces becomes pronounced. Thus, after drying, the outer electrode is flattened on the end surface, the main surfaces, and the side surfaces. However, since such flattening is achieved with a large amount of application of the outer electrode paste to the main surfaces and the side surfaces, an angle between the main surface or the side surface of the multilayer body and a surface of an edge portion of the outer electrode is increased. Thus, the edge portion of the outer electrode is likely to peel off from the multilayer body.

### SUMMARY OF THE INVENTION

Example embodiments of the present invention provide multilayer ceramic capacitors each including a multilayer body with a predetermined size, and each including an outer electrode to reduce or prevent, in the outer electrode, bulging of a central portion relative to a surrounding portion and peeling of an edge portion from the multilayer body.

The inventors of example embodiments of the present invention have discovered that it is possible to provide an outer electrode to reduce or prevent bulging of a central portion relative to a surrounding portion and reduce or prevent peeling of an edge portion from a multilayer body, by adjusting a material of an outer electrode and a size of the outer electrode at a predetermined location.

An example embodiment of the present invention provides a multilayer ceramic capacitor including a multilayer body including a stack of a dielectric layer and an inner electrode, two main surfaces facing each other in a stacking direction, two side surfaces facing each other in a width direction crossing the stacking direction, and two end surfaces facing each other in a length direction crossing the stacking direction and the width direction, and an outer electrode on an outer surface of the multilayer body, in which the multilayer body has a dimension of about 0.8 mm or more in the stacking direction, a dimension of about 0.8 mm or more in the width direction, and a dimension of about 1.6 mm or more in the length direction, the outer electrode includes Cu, a thickness of the outer electrode in the stacking direction on one of the main surfaces of the multilayer body is about 15 μm or less, an angle, at the main surface of the multilayer body, between the main surface and a surface of an edge portion of the outer electrode is about 39.1 degrees or less, and a ratio b/a of a maximum thickness b to a distance a is about 2.8 or less, the maximum thickness b being a maximum thickness of the outer electrode in the length direction when a section of the multilayer ceramic capacitor defined by the stacking direction and the length direction at a center of the multilayer ceramic capacitor in the width direction is viewed, and the distance a being, when a section of the multilayer ceramic capacitor defined by the stacking direction and the length direction at a position where, of the inner electrode exposed at one of the end surfaces of the multilayer body, a side surface portion is exposed is viewed, a distance in the length direction from one of end edges of the inner electrode layer positioned at each of both ends in the stacking direction to a surface of the outer electrode.

Example embodiments of the present invention provide multilayer ceramic capacitors that each include a multilayer body with a predetermined size, and include an outer electrode to reduce or prevent bulging of a central portion relative to a surrounding portion and to reduce or prevent peeling of the edge portion from the multilayer body.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor 1 according to an example embodiment according to the present invention.

FIG. 2 is a sectional view of the multilayer ceramic capacitor 1 in FIG. 1 taken along line II-II.

FIG. 3 is a sectional view of the multilayer ceramic capacitor 1 in FIG. 1 taken along line III-III.

FIG. 4A schematically illustrates a section of a multilayer ceramic capacitor according to an example embodiment of the present invention, and FIG. 4B schematically illustrates a section of a multilayer ceramic capacitor of the related art.

FIG. 5 illustrates the appearance and cutting positions of a multilayer body used when the flatness of an outer electrode is examined.

FIG. 6 illustrates, at a main surface of a multilayer body, an angle between the main surface and a surface of an edge portion of the outer electrode.

FIGS. 7A to 7C are for illustrating a step of applying an outer electrode paste to a fired multilayer chip body, that is, FIG. 7A illustrates a state in which the fired multilayer chip body is immersed in the outer electrode paste, FIG. 7B illustrates a state in which the fired multilayer chip body has been withdrawn, and an outward flow of the outer electrode paste from a central portion to the edge portion occurs, and FIG. 7C illustrates a state in which the outer electrode paste is dried.

### DETAILED DESCRIPTION OF THE EXAMPLE EMBODIMENTS

Hereinafter, example embodiments of a multilayer ceramic capacitor according to the present invention will be described. However, the present invention is not limited thereto. The drawings may be schematically illustrated in a simplified manner for description of the contents of example embodiments of the present invention, and there may be cases where the dimensional ratios of the illustrated elements themselves or the dimensional ratios between the illustrated elements do not match those in the present description. The elements in the present description may be omitted in the drawings or may be illustrated with a reduced number thereof.

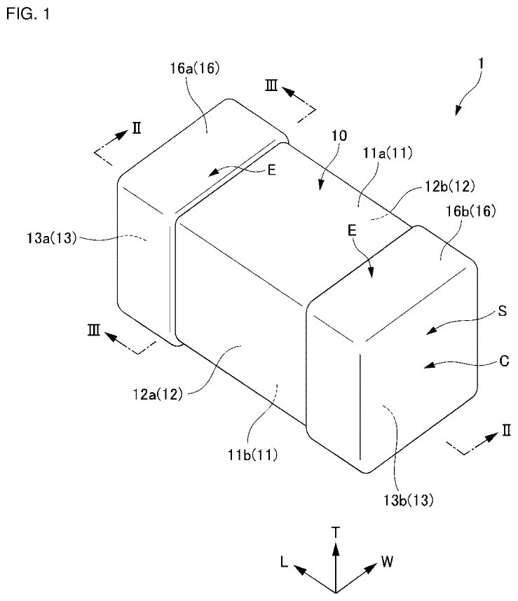

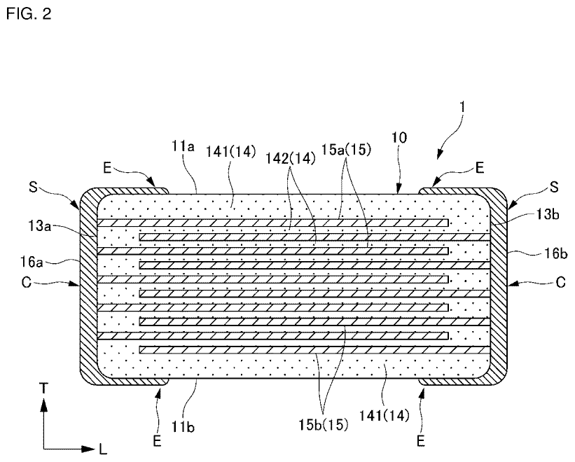

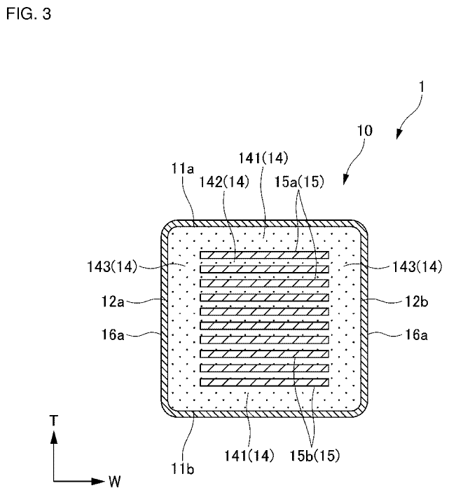

FIG. 1 is an external perspective view of a multilayer ceramic capacitor 1 in an example embodiment according to the present invention. FIG. 2 is a sectional view of the multilayer ceramic capacitor 1 in FIG. 1 taken along line II-II, and illustrates the section defined by a stacking direction T and a length direction L at the center of the multilayer ceramic capacitor 1 in a width direction W. FIG. 3 is a sectional view of the multilayer ceramic capacitor 1 in FIG. 1 taken along line III-III, and illustrates the section defined by the stacking direction T and the width direction W at the center of the multilayer ceramic capacitor 1 in the length direction L.

As illustrated in FIGS. 1 to 3, the multilayer ceramic capacitor 1 includes a multilayer body 10 having a rectangular or substantially rectangular parallelepiped shape and a pair of outer electrodes 16. The pair of outer electrodes 16 face each other as illustrated in FIG. 1.

Here, the direction where the pair of outer electrodes 16 face each other is the length direction L of the multilayer ceramic capacitor 1, the direction where a dielectric layer 14 and an inner electrode 15, which will be described later, are stacked is the stacking direction T, and the direction that is orthogonal or substantially orthogonal to both the length direction L and the stacking direction T is the width direction W. The length direction L, the stacking direction T, and the width direction W are orthogonal or substantially orthogonal to one another.

The multilayer body 10 includes a first end surface 13a and a second end surface 13b that face each other in the length direction L, a first main surface 11a and a second main surface 11b that face each other in the stacking direction T, and a first side surface 12a and a second side surface 12b that face each other in the width direction W.

Corner portions and ridge portions of the multilayer body 10 are preferably rounded. Here, the corner portions are each a portion at which three faces of the multilayer body 10 meet, and the ridge portions are each a portion at which two faces of the multilayer body 10 meet.

As illustrated in FIGS. 2 and 3, the multilayer body 10 includes a stack of multiple dielectric layers 14 and multiple inner electrodes 15. The inner electrodes 15 include first inner electrodes 15a and second inner electrodes 15b. The multilayer body 10 has a structure in which the first inner electrodes 15a and the second inner electrodes 15b are alternately stacked with the dielectric layers 14 interposed therebetween in the stacking direction T.

As illustrated in FIG. 3, the dielectric layers 14 include outer layers 141 each positioned, in the stacking direction T, on the outer side relative to the corresponding inner electrode 15 positioned on the outermost side in the stacking direction T, inner dielectric layers 142 each positioned between two inner electrodes 15 that are adjacent to each other in the stacking direction T, and margin portions 143 that are each a region including no inner electrode 15 when the ceramic body 10 is viewed in the stacking direction T.

That is, each of the outer layers 141 is positioned between the corresponding inner electrode 15 on the outermost side in the stacking direction T and a corresponding one of the first main surface 11a and the second main surface lib of the ceramic body 10. Each of the inner dielectric layers 142 is positioned between the corresponding first and second inner electrodes 15a and 15b that are adjacent to each other in the stacking direction T. The margin portions 143 are positioned on the outer sides relative to the outer layers 141 and the inner dielectric layers 142 in the width direction W.

In an example of a manufacturing process of the multilayer ceramic capacitor 1, the margin portions 143 may be formed integrally with the inner dielectric layers 142 or may be formed separately from the inner dielectric layers 142. When the margin portions 143 are formed separately from the inner dielectric layers 142, for example, after ceramic green sheets with inner electrode patterns are stacked, the margin portion 143 can be formed by attaching a ceramic green sheet to a portion of the stack on the outer side in the width direction W and by performing firing. In this case, a physical boundary exists between the multilayer body including the outer layers 141, the inner electrodes 15, and the inner dielectric layers 142, and the margin portion 143.

In the manufacture of the multilayer body, first, an unfired multilayer chip that forms such a structure described above after firing is prepared. The multilayer chip is then fired into a fired multilayer chip body. An outer electrode paste, which will be described later, is applied to an outer surface of the fired multilayer chip body, and the fired multilayer chip body is then fired with the outer electrode paste into a multilayer body with outer electrodes, that is, a multilayer ceramic capacitor is completed.

In the following description regarding an example of a manufacturing method and the like, a step of applying the outer electrode paste to the fired multilayer chip body before formation of the outer electrode will be described in detail. In the present description, as the fired multilayer chip body and the multilayer body have the same or substantially the same shape and structure, the fired multilayer chip body and each portion thereof will be described while being denoted by the same reference signs as those of the multilayer body.

The multilayer body is formed by applying a paste in which promotion of convection during drying after application and reduction or prevention of the thickness of a central portion C of the outer electrode 16 are achieved, to an end surface and portions of the main surfaces and portions of the side surfaces of the fired multilayer chip body that are continuous from the end surface, and by performing firing. However, since the amount of the applied outer electrode paste is increased when the size of the fired multilayer chip body 10 is increased, the formed outer electrode 16 is likely to have a convex shape in which the central portion C is thicker and a surrounding portion S is thinner. As a result of the promotion of convection during drying from there, the thickness of the outer electrode 16 on the main surfaces 11 and the side surfaces 12 of the fired multilayer chip body 10 is increased, and an angle between the main surface 11 or the side surface 12 and a surface of an edge portion E is increased. Thus, the edge portion E of the outer electrode 16 is likely to peel off from the multilayer body. In example embodiments of the present invention, for example, even when the multilayer body 10 after firing has a dimension of about 0.8 mm or more in the stacking direction, a dimension of about 0.8 mm or more in the width direction, and a dimension of about 1.6 mm or more in the length direction, there can be formed the outer electrode that is able to reduce or prevent bulging of the central portion C relative to the surrounding portion S, without forming a convex shape, and is also able to reduced or prevent peeling of the edge portion E from the multilayer body 10.

The outer electrodes 16 include a first outer electrode 16a and a second outer electrode 16b.

The first outer electrode 16a is disposed on the first end surface 13a of the multilayer body 10 and connected to the first inner electrodes 15a. The first outer electrode 16a extends from the first end surface 13a to a portion of the first main surface 11a and a portion of the second main surface 11b. The first outer electrode 16a extends from the first end surface 13a to a portion of the first side surface 12a and a portion of the second side surface 12b.

The second outer electrode 16b is disposed on the second end surface 13b of the multilayer body 10 and connected to the second inner electrodes 15b. The second outer electrode 16b extends from the second end surface 13b to a portion of the first main surface 11a and a portion of the second main surface 11b. The second outer electrode 16b extends from the second end surface 13b to a portion of the first side surface 12a and a portion of the second side surface 12b.

Here, the central portion C of the outer electrode 16 refers to a region, in the outer electrode 16 continuously covering the end surface 13, portions of the main surfaces 11, and portions of the side surfaces 12 of the multilayer body 10, positioned close to the center of the end surface 13, and the surrounding portion S of the outer electrode 16 refers to a region surrounding the central portion C of the outer electrode 16 on the end surface 13 of the multilayer body 10. The edge portion E of the outer electrode 16 refers to a region extending toward the end surface 13 of the multilayer body 10 from a peripheral edge of the outer electrode 16 that is formed over the entire or substantially the entire periphery of the multilayer body 10 across the main surfaces 11 and the side surfaces 12.

The outer electrode includes Cu, for example. Cu is blended as a component of the outer electrode paste, which will be described later, and defines the outer electrode by being applied to the end surface 13 of the fired multilayer chip body 10.

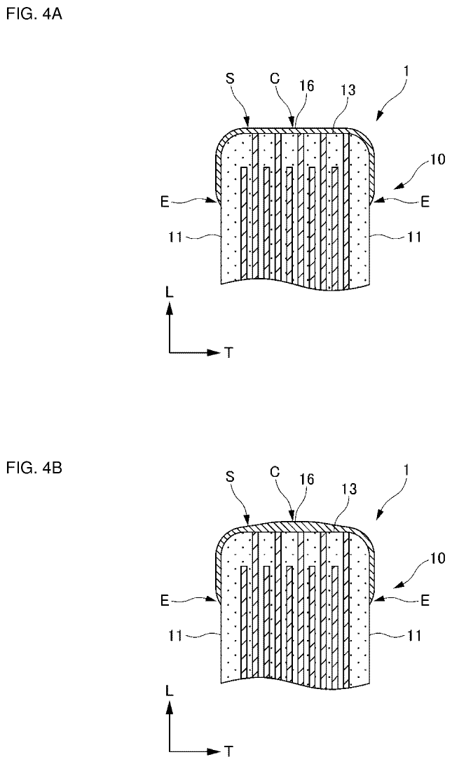

FIG. 4A schematically illustrates a section of the multilayer ceramic capacitor 1 according to the present example embodiment. On the other hand, FIG. 4B schematically illustrates a section of a multilayer ceramic capacitor 1 of the related art. The figures each correspond to the sectional view of the multilayer ceramic capacitor 1 in FIG. 1 taken along line II-II, but the figures each schematically illustrate, while enlarging, the shape of the section of the outer electrode for illustrating the shape of the outer electrode.

As illustrated in FIG. 4B, an outer electrode 16 of the multilayer ceramic capacitor 1 of the related art has a convex shape in which a central portion C is thicker and a surrounding portion S is thinner. In contrast, the outer electrode 16 of the multilayer ceramic capacitor 1 according to the present example embodiment has a flat shape as illustrated in FIG. 4A, and formation of a convex shape as in the related art is reduced or prevented. Thus, when compared at the same size, an internal element can be increased in size by making the outer electrode thinner, and the capacitance can thus be increased.

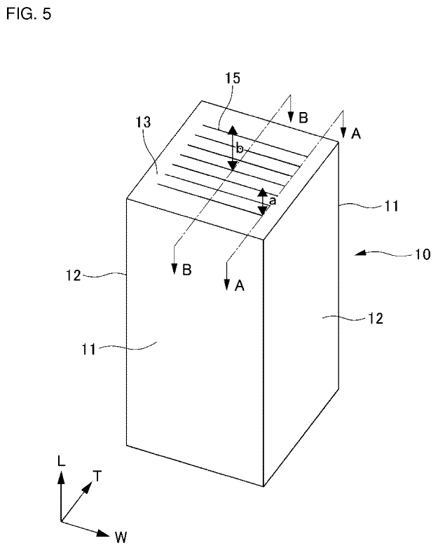

The flatness of the outer electrode can be evaluated using the ratio between the film thicknesses of the outer electrode when the multilayer ceramic capacitor is cut along line A-A and line B-B in FIG. 5. That is, measurement is performed for a maximum thickness b of the outer electrode in the length direction L when the B-B section of the multilayer ceramic capacitor defined by the stacking direction T and the length direction L at the center of the multilayer ceramic capacitor in the width direction W is viewed, and, when the A-A section of the multilayer ceramic capacitor defined by the stacking direction T and the length direction L at a position where, of the inner electrode 15 exposed at the end surface 13 of the multilayer body 10, a side surface portion is exposed is viewed, measurement is performed for a distance a in the length direction L from one of the end edges of the inner electrode layers 15 positioned at both ends in the stacking direction T to the surface of the outer electrode. The outer electrode provided on the end surface 13 and portions of the main surfaces 11 and portions of the side surfaces 12 that are continuous from the end surface 13 is omitted in FIG. 5 for illustrating line A-A and line B-B in the multilayer body 10.

The flatness of the outer electrode can be evaluated using a ratio b/a between the maximum thickness b and the distance a that are measured by the above-described method. The b/a representing the flatness of the outer electrode is preferably closer to 1, and the b/a of the multilayer ceramic capacitor 1 according to the present invention is, for example, about 2.8 or less.

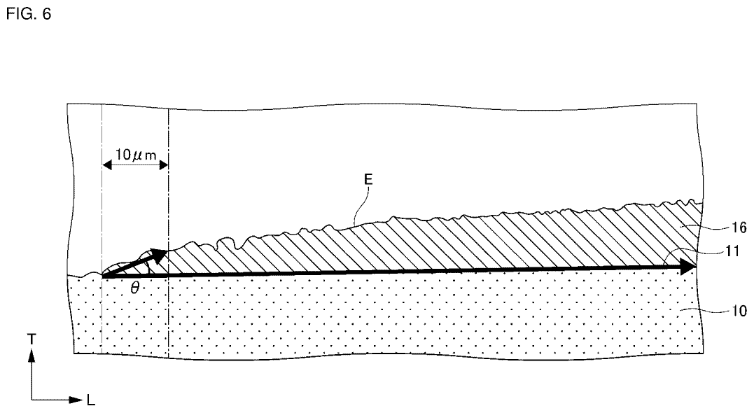

FIG. 6 is an enlarged view of the edge portion E of the outer electrode 16 on the main surface 11 of the multilayer body 10 in the B-B section in FIG. 5. At the main surface 11 of the multilayer body 10, an angle between the main surface 11 and the surface of the edge portion E of the outer electrode 16 is obtained using an angle θ between the main surface 11 of the multilayer body 10 and a straight line connecting the peripheral edge of the outer electrode 16 and the surface of the outer electrode 16 at a position, for example, about 10 μm away from the peripheral edge in the length direction L.

In the multilayer ceramic capacitor 1 according to the present example embodiment, the angle between the main surface 11 of the multilayer body 10 and the surface of the edge portion E of the outer electrode 16 is, for example, about 39.1 degrees or less. The thickness of the outer electrode 16 in the stacking direction T on the main surface 11 of the multilayer body 10 is, for example, about 15 μm or less.

The multilayer ceramic capacitor 1 can be manufactured by forming the outer electrode 16 by, for example, applying the outer electrode paste to the end surface 13 and portions of the main surfaces 11 and portions of the side surfaces 12 of the fired multilayer chip body 10 that are continuous from the end surface 13 and then by drying and firing the outer electrode paste with the fired multilayer chip body 10.

The outer electrode paste in the present example embodiment includes a binder, Cu, a glass filler, and a solvent.

A known binder can be used for the binder, and a preferable binder includes a resin including an Ethocel (registered trademark) resin and an acrylic resin that are copolymerized. By including such a resin, the interfacial tension that occurs between the resin and the solvent increases the force of the outward flow of the outer electrode paste from the central portion C to the surrounding portion S, thus increasing the fluidity. Thus, when the outer electrode paste is applied, formation of a shape in which the central portion C bulges relative to the surrounding portion S can be reduced or prevented.

The Ethocel resin is, for example, at least one of ethyl cellulose, methyl cellulose, hydroxypropyl cellulose, trityl cellulose, acetyl cellulose, carboxymethyl cellulose, or nitro cellulose.

The acrylic resin is, for example, at least one of isobutyl methacrylate, methyl methacrylate, hydroxyethyl methacrylate, hydroxypropyl methacrylate, n-butyl methacrylate, or 2-ethylhexyl methacrylate.

The Ethocel resin and the acrylic resin are at least partially copolymerized. In one example of copolymerization, the OH group of the Ethocel resin is substituted with a vinyl group, and the Ethocel resin and the acrylic resin are bonded to each other through the substituted vinyl group.

A dried coating film obtained by applying the outer electrode paste including the resin including the Ethocel resin and the acrylic resin that are at least partially copolymerized has the flexibility derived from the acrylic resin and the rigidity derived from the Ethocel resin and has sufficient strength as a dried coating film.

On the other hand, use of an outer electrode paste including an Ethocel resin and an acrylic resin that are present merely as separate resins without copolymerization therebetween makes the dried coating film brittle. Thus, chipping or peeling of the dried coating film may occur in a multilayer ceramic capacitor applied with such an outer electrode paste, in a transport process thereof.

Cu is in the form of particles made of at least one of Cu and a Cu alloy, for example. An average particle size D50 of Cu is preferably, for example, about 0.3 μm or less to form a thin and dense outer electrode.

For the glass filler, for example, an oxide such as Ba, Sr, Ca, Zn, Al, Si, or B can be used. An average particle size D50 of the glass filler is preferably, for example, about 1.0 μm or less for forming a thin and dense outer electrode.

The solvent may include, for example, at least one of terpineol, dihydroterpineol, dihydroterpinyl acetate, propylene glycol phenyl ether, benzyl alcohol, texanol, or butyl carbitol acetate.

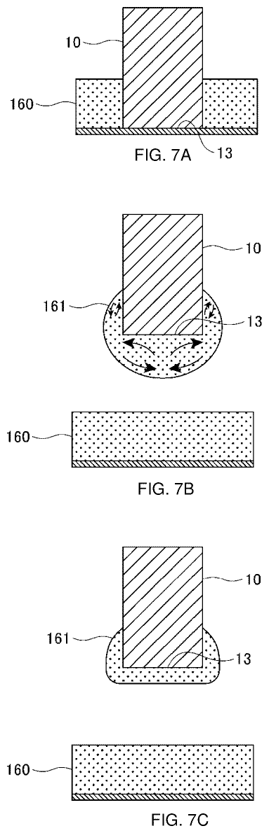

FIGS. 7A to 7C illustrate steps of applying an outer electrode paste 160 to the fired multilayer chip body 10.

The end surface 13 of the fired multilayer chip body 10 is immersed in the outer electrode paste 160 (FIG. 7A) and is then withdrawn (FIG. 7B). When the fired multilayer chip body 10 is withdrawn, Marangoni convection occurs, as indicated by the arrows in FIG. 7B, inside an outer electrode paste 161 adhering to the fired multilayer chip body 10.

Since the surrounding portion or the edge portion tends to dry out more quickly than the central portion, the concentration of the solvent therein decreases. The solvent is then supplied from the central portion so as to compensate for the decrease in the concentration of the solvent, and an outward flow occurs from the central portion to the surrounding portion and further to the edge portion (FIG. 7B).

Since the Ethocel resin has rigidity and heat storage properties, the Ethocel resin, in a drying step, plays a role in reducing or preventing the outer electrode paste from solidifying during flow and in facilitating the outward flow. Thus, the flow of the outer electrode paste from the central portion to the surrounding portion is promoted, thus reducing or preventing the outer electrode paste from forming a shape bulging outward in the central portion (FIG. 7C).

As described above, by reducing or preventing formation of a shape in which the central portion bulges relative to the surrounding portion, the multilayer ceramic capacitor including the outer electrodes having a flat shape can be manufactured.

As an example of a method for applying the outer electrode paste to the end surface 13 and a portion of the main surface of the fired multilayer chip body 10, the method for immersing the end surface 13 and a portion of the main surface of the fired multilayer chip body 10 into the outer electrode paste 160 has been described, but the method for applying the outer electrode paste is not limited thereto.

An evaluation test on the multilayer ceramic capacitor according to the present invention and an evaluation test on the multilayer ceramic capacitor of the related art will be described below as Example 1 and Comparative Example 1, respectively.

The following materials were kneaded by a roll mill into an outer electrode paste A.
Spherical Cu powder having an average particle size D50 of about 0.3 μm: about 40.6 wt %
Ba—B—Si glass powder: about 5.6 wt %
Resin in which Ethocel resin and acrylic resin are copolymerized: about 5.2 wt %
Terpineol: about 48.6 wt %

The outer electrode paste was applied onto a flat surface using a doctor blade to a thickness of about 600 μm, for example. An end surface 13 of a fired multilayer chip body 10 that is, for example, used for forming a multilayer ceramic capacitor 1 having a length of about 3.2 mm in the length direction L, a length of about 1.6 mm in the stacking direction T, and a length of about 1.6 mm in the width direction W was immersed in the applied outer electrode paste 160 and withdrawn at a speed of about 0.1 mm/sec.

Next, in order to adjust the thickness of the outer electrode paste 161 adhering to the fired multilayer chip body 10, the outer electrode paste was applied onto a flat surface using a doctor blade to a thickness of about 400 μm, for example, and the end surface 13 of the fired multilayer chip body 10 was re-immersed in the applied outer electrode paste 160 and withdrawn at a speed of about 0.1 mm/sec.

The fired multilayer chip body 10 was allowed to stand in an oven heated to about 150° C. for about 10 minutes for drying and was then fired at about 700° C. in N₂, for example.

In the above-described example, immersion into the outer electrode paste is performed twice, and the depth of the first immersion is about 600 μm whereas the depth of the second immersion is about 400 μm, but immersion into the outer electrode paste may be performed multiple times without being limited thereto. Although the depths of immersion into the outer electrode paste 161 are not limited to about 600 μm and about 400 μm, for example, the depth of immersion is preferably gradually reduced to eliminate an excess outer electrode paste 160 that adheres to the end surface 13 of the fired multilayer chip body 10.

A specific example of a measurement method for the film thicknesses of the outer electrode in the A-A section and the B-B section of the multilayer ceramic capacitor after firing is as follows.

A synthetic resin was solidified around the multilayer ceramic capacitor 1 so that the side surfaces 12 of the multilayer body 10 were exposed. Next, the multilayer body 10 was provided with one of the side surfaces 12 thereof positioned on the lower side, the section (A-A section) polished to the depth where, of the inner electrode 15 that is exposed at the end surface 13 of the multilayer body 10, a side surface portion begins to be exposed was observed using a metallurgical microscope (BX51M manufactured by Olympus Corporation), and a distance in the length direction L from one of the end edges of the inner electrodes 15 positioned at both ends in the stacking direction T to the surface of the outer electrode was measured in six fields of view. The observation magnification was set using, for example, a 10× ocular lens and a 100× objective lens. The distance a was defined as an average of about 16.5 μm over the six fields of view.

Subsequently, the section (B-B section) polished to the center in the width direction W was observed, and the maximum film thickness of the outer electrode 16 in the length direction L on the end surface 13 of the multilayer body 10 was measured in three fields of view. The maximum thickness b of the outer electrode was defined as, for example, an average of about 44.5 μm over the three fields of view.

The ratio b/a between the maximum thickness b and the distance a described above, which is an index for evaluating the flatness of the outer electrode, was about 2.7, for example.

In the B-B section, for example, the angle between the main surface 11 of the multilayer body 10 and the surface of the edge portion E of the outer electrode 16 was about 20.7 degrees on average over the six fields of view, and, in each of the six fields of view, no peeling of the edge portion E of the outer electrode 16 from the main surface 11 of the multilayer body 10 was observed.

In the B-B section, as a result of observing a portion having a maximum film thickness, in the stacking direction T, of the outer electrode 16 on the main surface 11 of the multilayer body 10 using a 10× ocular lens and a 100× objective lens, the average over the six fields of view was about 13.8 μm, for example.

Flattening of the formed outer electrode 16 and reduction or prevention of peeling of the edge portion E of the outer electrode 16 during firing were achieved by adjusting the shape of the outer electrode paste 161 applied to the fired multilayer chip body 10 and by controlling the convection of the outer electrode paste 161 induced by evaporation of the solvent.

The following materials were kneaded by a roll mill into an outer electrode paste B.
Flattened Cu powder having an average particle size D50 of 4 μm: about 67.8 wt %
Ba—B—Si glass powder: about 8.3 wt %
Acrylic resin: about 6.6 wt %
Terpineol: about 17.3 wt %

The outer electrode paste B is a paste that has been used as a paste for an outer electrode of multilayer ceramic capacitors.

After being subjected to immersion and re-immersion using the outer electrode paste B, a fired multilayer chip body was allowed to stand in an oven heated to about 150° C. for about 10 minutes and was then fired at about 800° C. in N₂, for example.

In the A-A section and the B-B section of the multilayer ceramic capacitor, the ratio b/a, which is an index for evaluating the flatness of the outer electrode, was, for example, about 10.3 as a result of measurement performed similarly to Example 1.

As a result of measurement performed by a method the same as or similar to that of Example 1, no peeling of the edge portion E of the outer electrode 16 was observed, and the average angle over the six fields of view was about 20.3 degrees.

The average over the six fields of view was about 22.8 μm as a result of measurement performed by a method the same as or similar to that of Example 1.

With the outer electrode paste B, peeling of the edge portion E of the outer electrode 16 did not occur on the main surface of the multilayer body 10, but no flattening phenomenon during evaporation of the solvent was observed. Thus, thinning of the outer electrode was not achieved.

Together with the results of Example 1 and Comparative Example 1, the results of another example and other comparative examples are provided below.

TABLE 1

| | | | | Outer- | Presence or | Angle of |
|---|---|---|---|---|---|---|
| | | | | electrode | absence of | edge-portion |
| | | | | thickness in | peeling of edge | surface of |
| | | Doctor-blade | Outer- | stacking | portion of outer | outer |
| | Outer | clearance | electrode | direction on | electrode on | electrode on |
| | electrode | during re- | flatness | main surface | main surface | main surface |
| | paste | immersion | b/a | (B-B section) | (B-B section) | (B-B section) |
| Example 1 | A | 400 μm | 2.7 | 13.8 μm | None | 20.7° |
| Example 2 | A | 250 μm | 2.8 | 15.1 μm | None | 39.1° |
| Comparative | B | 400 μm | 10.3 | 22.8 μm | None | 20.3° |
| Example 1 | | | | | | |
| Comparative | A | 50 μm | 3.9 | 17.5 μm | Observed | 53.7° |
| Example 2 | | | | | | |
| Comparative | A | 100 μm | 3.6 | 16.9 μm | Observed | 46.1° |
| Example 3 | | | | | | |
| Comparative | A | 500 μm | 3.4 | 17.8 μm | Observed | 56.3° |
| Example 4 | | | | | | |

| | | | |
|---|---|---|---|
| Comparative | A | No re- | Cracking occurred in outer electrode during firing due to |
| Example 5 | | immersion | thickness increase in length direction on end surface |

In order to obtain an outer electrode having a flat shape in which bulging of the central portion C is reduced or prevented, the index b/a for evaluating the flatness of the outer electrode is preferably about 2.8 or less, for example. In order to reduce or prevent peeling of the edge portion E of the outer electrode on the main surface of the multilayer body, the thickness of the outer electrode in the stacking direction T is preferably about 15.1 μm or less, for example, and the angle between the main surface of the multilayer body and the surface of the edge portion of the outer electrode is preferably, for example, about 39.1 degrees or less.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a stack of a dielectric layer and an inner electrode, two main surfaces facing each other in a stacking direction, two side surfaces facing each other in a width direction crossing the stacking direction, and two end surfaces facing each other in a length direction crossing the stacking direction and the width direction; and
an outer electrode on an outer surface of the multilayer body; wherein
the multilayer body has a dimension of about 0.8 mm or more in the stacking direction, a dimension of about 0.8 mm or more in the width direction, and a dimension of about 1.6 mm or more in the length direction;
the outer electrode includes Cu;
a thickness of the outer electrode in the stacking direction on one of the main surfaces of the multilayer body is about 15 μm or less;
an angle, at the main surface of the multilayer body, between the main surface and a surface of an edge portion of the outer electrode is about 39.1 degrees or less; and
a ratio b/a of a maximum thickness b to a distance a is about 2.8 or less, the maximum thickness b being a maximum thickness of the outer electrode in the length direction when a section of the multilayer ceramic capacitor defined by the stacking direction and the length direction at a center of the multilayer ceramic capacitor in the width direction is viewed, and the distance a being, when a section of the multilayer ceramic capacitor defined by the stacking direction and the length direction at a position where, of the inner electrode exposed at one of the end surfaces of the multilayer body, a side surface portion is exposed is viewed, a distance in the length direction from one of end edges of the inner electrode layer positioned at each of both ends in the stacking direction to a surface of the outer electrode.

2. The multilayer ceramic capacitor according to claim 1, wherein the multilayer body includes corner portions and ridge portions.

3. The multilayer ceramic capacitor according to claim 1, wherein the maximum thickness of the outer electrode is about 15 μm or less.

4. The multilayer ceramic capacitor according to claim 1, wherein the Cu included in the outer electrode is provided in the form of particles.

5. The multilayer ceramic capacitor according to claim 4, wherein an average particle size D50 of the Cu is about 0.3 μm or less.

6. A manufacturing method of the multilayer ceramic capacitor according to claim 1, the manufacturing method comprising:
applying, to at least one of the two end surfaces and at least one of the two main surfaces of the multilayer body not subjected to firing, an outer electrode paste including a resin in which an Ethocel resin and an acrylic resin are copolymerized, Cu with an average particle size D50 of about 0.3 μm or less, and a glass filler with an average particle size D50 of about 1.0 μm or less.

7. The manufacturing method of the multilayer ceramic capacitor according to claim 6, wherein, by performing multiple immersions into an outer electrode paste, the applying the outer electrode paste to the at least one of the two end surfaces and the at least one of the two main surfaces of the multilayer body not subjected to firing is performed.

8. The manufacturing method of the multilayer ceramic capacitor according to claim 7, wherein the multiple immersions into the outer electrode paste are performed with a depth of immersion gradually reduced.

9. The manufacturing method of the multilayer ceramic capacitor according to claim 6, wherein the Ethocel resin includes at least one of ethyl cellulose, methyl cellulose, hydroxypropyl cellulose, trityl cellulose, acetyl cellulose, carboxymethyl cellulose, or nitro cellulose.

10. The manufacturing method of the multilayer ceramic capacitor according to claim 6, wherein the acrylic resin includes at least one of isobutyl methacrylate, methyl methacrylate, hydroxyethyl methacrylate, hydroxypropyl methacrylate, n-butyl methacrylate, or 2-ethylhexyl methacrylate.

11. The manufacturing method of the multilayer ceramic capacitor according to claim 6, wherein the glass filler includes an oxide of Ba, Sr, Ca, Zn, Al, Si, or B.
